(19) United States
(12) Patent Application Publication
(10) Pub. No.: US 2017/0019732 A1
(43) Pub. Date: Jan. 19, 2017

(54) DEVICE FOR CONTROLLING A LOUDSPEAKER

(71) Applicant: DEVIALET, Paris (FR)

(72) Inventors: Eduardo MENDES, CHABEUIL (FR); Pierre-Emmanuel CALMEL, LE CHESNAY (FR); Antoine PETROFF, PARIS (FR); Jean-Loup AFRESNE, PARIS (FR)

(21) Appl. No.: 15/122,083

(22) PCT Filed: Feb. 18, 2015
(86) PCT No.: PCT/EP2015/053431

§ 371 Date: Aug. 26, 2016

(30) Foreign Application Priority Data
Feb. 26, 2014 (FR) 1451564

(51) Int. Cl. H04R 3/00; H04R 9/06; H04R 29/00

(52) U.S. Cl. CPC H04R 3/007; H04R 29/003; H04R 9/06; H04R 1/2834

(57) ABSTRACT

The present invention relates to a device for controlling a loudspeaker (14) in an enclosure, comprising:

an input for an audio signal (S_{audio}_{_}_{ref}) to be reproduced;

an output for supplying an excitation signal from the loudspeaker.

It comprises a control unit comprising:

means (24, 25) for calculating a desired dynamic value (A_{ref}) of the loudspeaker diaphragm based on the audio signal (S_{audio}_{_}_{ref}) to be reproduced and the structure of the enclosure;

means (26) for calculating a plurality of desired dynamic values (A_{ref}, dA_{ref}/dt, V_{ref}, X_{ref}) of the loudspeaker diaphragm at each moment based on only the desired dynamic value (A_{ref});

a mechanical model (36) of the loudspeaker; and

means (70, 80, 90) for calculating the excitation signal of the loudspeaker at each moment, without feedback loop, from the mechanical model (36) of the loudspeaker and desired dynamic values (A_{ref}, dA_{ref}/dt, V_{ref}, X_{ref}).

The present invention relates to a device for controlling a loudspeaker in an enclosure, comprising:

an input for an audio signal to be reproduced;

an output for supplying an excitation signal from the loudspeaker.

Loudspeakers are electromagnetic devices that convert an electrical signal into an acoustic signal. They introduce a nonlinear distortion that may greatly affect the obtained acoustic signal.

Many solutions have been proposed to control loudspeakers so as to make it possible to eliminate the distortions in the behavior of the loudspeaker through an appropriate command.

A first type of solution uses mechanical sensors, typically a microphone, in order to implement an enslavement that makes it possible to linearize the operation of the loudspeaker. The major drawback of such a technique is the mechanical bulk and the non-standardization of the devices, as well as the high costs.

Examples of such solutions are for example described in documents EP 1 351 543, U.S. Pat. No. 6,684,204, US 2010/017 25 16, and U.S. Pat. No. 5,694,476.

In order to avoid the use of an unwanted mechanical sensor, open loop-type controls have been considered. They do not require costly sensors. They optionally only use a measurement of the voltage and/or current applied across the terminals of the loudspeaker.

Such solutions are for example described in documents U.S. Pat. No. 6,058,195 and U.S. Pat. No. 8,023,668.

These solutions nevertheless have drawbacks in that the set of nonlinearities of the loudspeaker is not taken into account and these systems are complex to install and do not offer complete freedom for the choice of the corrected behavior obtained from the equivalent loudspeaker.

Document U.S. Pat. No. 6,058,195 uses a so-called “mirror filter” technique with current control. This technique makes it possible to eliminate the nonlinearities in order to obtain a predetermined model. The implemented estimator E produces an error signal between the measured voltage and the voltage predicted by the model. This error is used by the update circuit of the parameters U. In light of the number of estimated parameters, the convergence of the parameters toward their true values is highly improbable under normal operating conditions.

U.S. Pat. No. 8,023,668 proposes an open loop control model that offsets the unwanted behaviors of the loudspeaker relative to a desired behavior. To that end, the voltage applied to the loudspeaker is corrected by an additional voltage that cancels out the unwanted behaviors of the loudspeaker relative to the desired behavior. The control algorithm is done by discrete-time discretization of the model of the loudspeaker. This makes it possible to predict the position the diaphragm will have in the following time and compare that position with the desired position. The algorithm thus performs a kind of infinite gain enslavement between a desired model of the loudspeaker and the model of the loudspeaker so that the loudspeaker follows the desired behavior.

As in the preceding document, the command implements a correction that is calculated at each moment and added to the input signal, even though this correction in document U.S. Pat. No. 8,023,668 does not implement a closed feedback loop.

The mechanisms for calculating a correction added to the input signal are complex to implement, and the obtained results are sometimes unsatisfactory, the correction model proving inappropriate or ineffective for certain operating conditions or for certain shapes of the input signal.

The invention aims to propose a satisfactory control of the loudspeaker that does not have the drawbacks related to the modification of the input signal by adding a correction signal calculated by comparison at each moment between a desired model and the model of the loudspeaker.

To that end, the invention relates to a loudspeaker control device of the aforementioned type, characterized in that it comprises a control unit comprising:

means for calculating a desired dynamic value of the loudspeaker diaphragm based on the audio signal to be reproduced and the structure of the enclosure;

means for calculating a plurality of desired dynamic values of the loudspeaker diaphragm at each moment based on only the desired dynamic value;

mechanical modeling means of the loudspeaker; and

means for calculating the excitation signal of the loudspeaker at each moment, without feedback loop, from the mechanical model of the loudspeaker and desired dynamic values.

According to specific embodiments, the control device comprises one or more of the following features:

said control unit further comprises an electric model of the loudspeaker; and the means for calculating the excitation signal at each moment are able to calculate the excitation signal further based on the electric model of the loudspeaker;

the electric model of the loudspeaker takes account of:
a resistance representative of the magnetic losses of the loudspeaker;
an inductance representative of a para-inductance resulting from the effect of the Foucault currents in the loudspeaker;

the electric model of the loudspeaker takes account of the variation of the inductance of the loudspeaker coil based on the intensity circulating in the loudspeaker;

the electric model of the loudspeaker takes account of the variation of the inductance of the loudspeaker coil based on the position of the coil diaphragm;

the electric model of the loudspeaker takes account of the variation of the magnetic flux captured by the loudspeaker coil based on the intensity circulating in the loudspeaker;

the electric model of the loudspeaker takes account of the variation of the magnetic flux captured by the loudspeaker coil based on the position of the coil diaphragm;

the electric model of the loudspeaker takes account of the variation of the derivative of the inductance relative to time of the loudspeaker coil based on the intensity circulating in the loudspeaker;

the electric model of the loudspeaker takes account of the variation of the derivative of the inductance relative to time of the loudspeaker coil based on the position of the coil diaphragm;

the electric model of the loudspeaker takes account of the variation of the resistance of the loudspeaker coil based on a measured temperature of the magnetic circuit of the loudspeaker;

the electric model of the loudspeaker takes account of the variation of the resistance of the loudspeaker coil based on an intensity measured in the loudspeaker coil;

the means for calculating the desired dynamic values based on the audio signal to be reproduced comprise at least one bounded integrator characterized by a cutoff frequency limiting the integration in the useful bandwidth below the cutoff frequency;

the plurality of desired dynamic values are the set of values at a given moment of four functions that are different-order derivatives of a same function;

the means for calculating desired dynamic values are able to provide calculations of desired dynamic values by integration and/or derivation of the audio signal to be reproduced;

the means for calculating the excitation signal, without feedback loop, from desired dynamic values are able to provide algebraic calculations of the intensity of the desired current in the coil and of the derivative relative to time of the intensity of the desired current in the coil;

the mechanical model of the loudspeaker takes account of the mechanical friction of the loudspeaker, and in that it comprises means so that the resistance depends on at least one of the desired dynamic values according to a nonlinear increasing function tending toward infinity when at least one of the desired dynamic values tends toward a predetermined value;

the plurality of desired dynamic values comprise the acceleration of the loudspeaker diaphragm and the position of the loudspeaker diaphragm, and in that it comprises means for limiting the acceleration in a predetermined interval, to limit the excursions of the position of the diaphragm beyond a predetermined value;

the means for calculating the dynamic value of the loudspeaker diaphragm are able to apply a correction that is different from the identity, and taking account of structural dynamic values of the enclosure that are different from the dynamic values relative to the loudspeaker diaphragm;

the enclosure comprises a vent and the structural dynamic values of the enclosure comprise at least one derivative of predetermined order of the position of the air displaced by the enclosure;

the structural dynamic values of the enclosure comprise the position of the air displaced by the enclosure;

the structural dynamic values of the enclosure comprise the speed of the air displaced by the enclosure;

the enclosure is a vented enclosure and the structural dynamic values of the enclosure depend on at least one of the following parameters:
acoustic leakage coefficient of the enclosure
inductance equivalent to the mass of air in the vent
compliance of the air in the enclosure;

the enclosure is a passive radiator enclosure and the structural dynamic values of the enclosure depend on at least one of the following parameters:
acoustic leakage coefficient of the enclosure
inductance equivalent to the mass of the diaphragm of the passive radiator
compliance of the air in the enclosure
mechanical losses of the passive radiator
mechanical compliance of the diaphragm.

The invention will be better understood upon reading the following description, provided solely as an example, and done in reference to the drawings, in which:

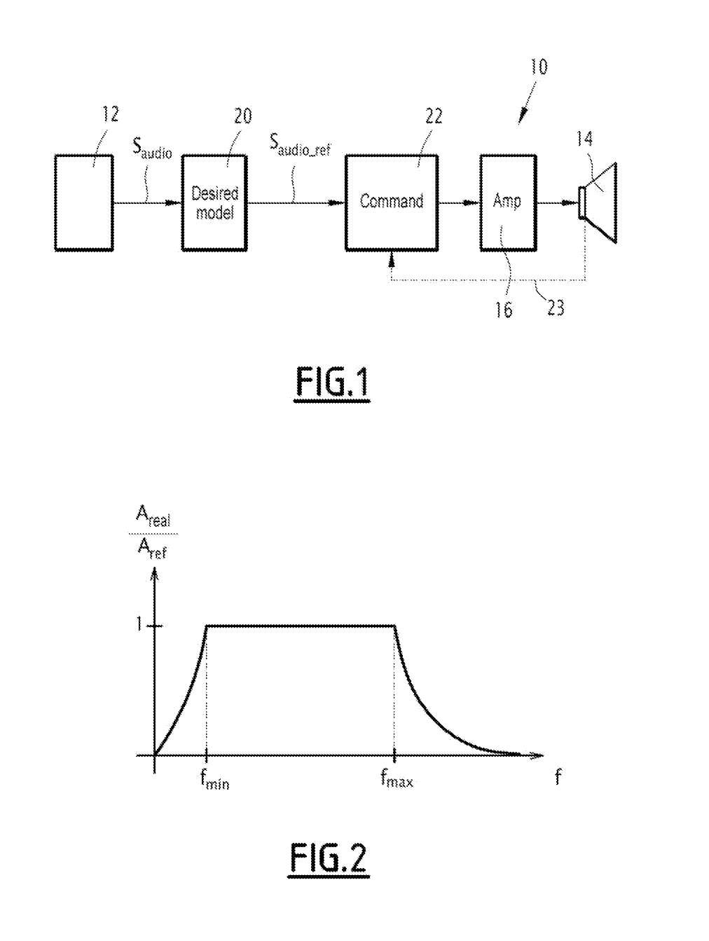

FIG. 1 is a diagrammatic view of a sound retrieval installation;

FIG. 2 is a curve illustrating a desired sound retrieval model for the installation;

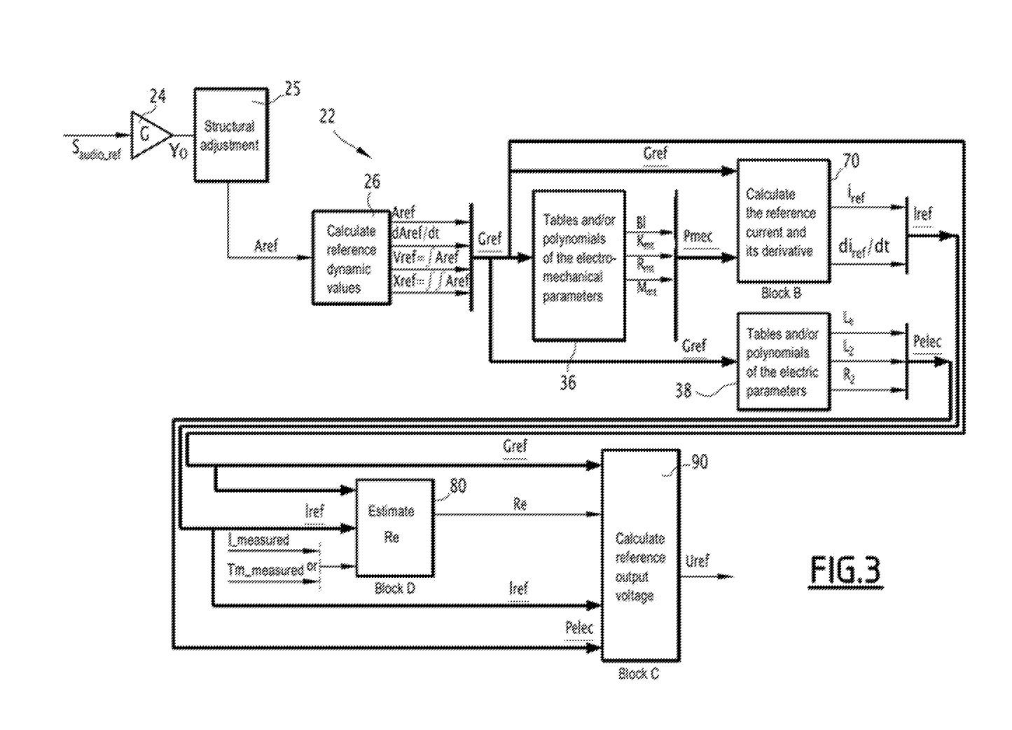

FIG. 3 is a diagrammatic view of the loudspeaker control unit;

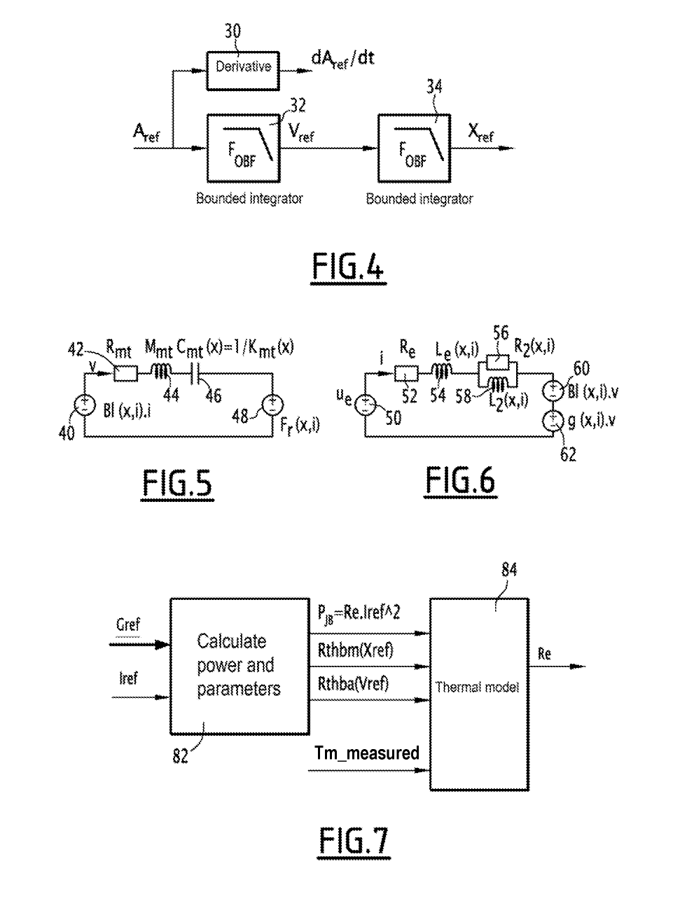

FIG. 4 is a detailed diagrammatic view of the unit for calculating reference dynamic values;

FIG. 5 is a view of a circuit representing the mechanical modeling of the loudspeaker so that it may be controlled in a closed enclosure;

FIG. 6 is a view of a circuit representing the electrical modeling of the loudspeaker so that it may be controlled;

FIG. 7 is a diagrammatic view of a first embodiment of the open loop estimating unit for the resistance of the loudspeaker;

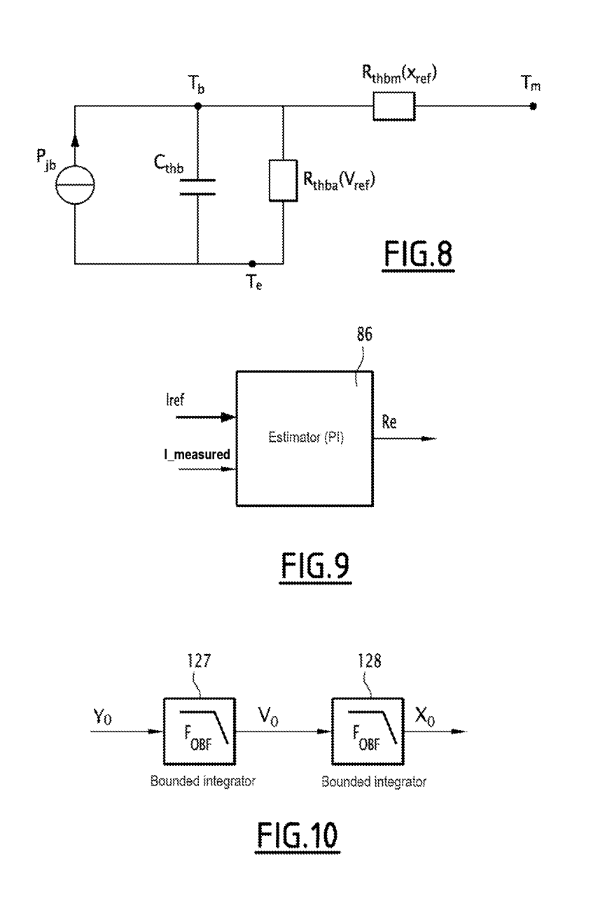

FIG. 8 is a view of a circuit of the loudspeaker thermal model;

FIG. 9 is a diagrammatic view identical to that of FIG. 7 of an alternative embodiment of the closed loop estimating unit for the resistance of the loudspeaker;

FIG. 10 is a detailed diagrammatic view of the structural adaptation unit;

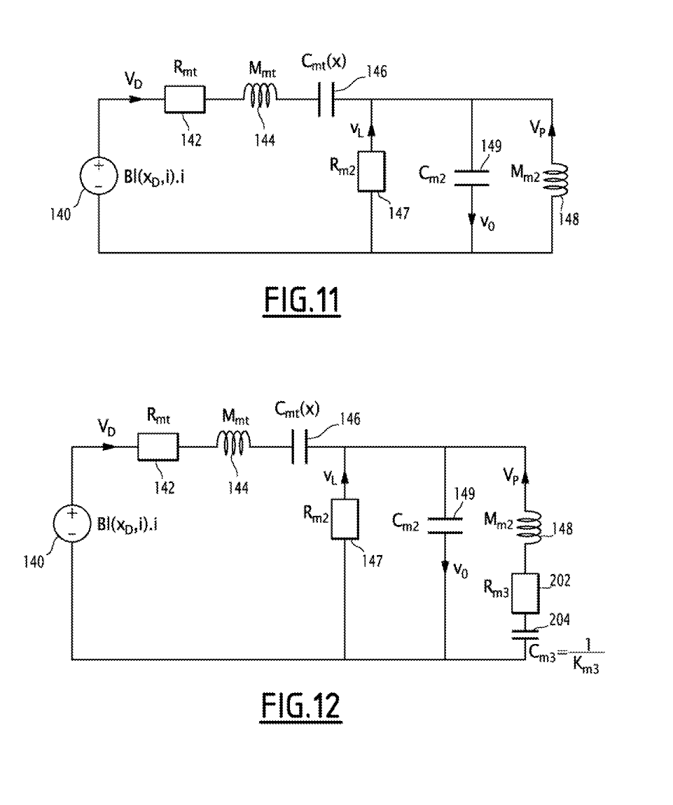

FIG. 11 is a diagrammatic view identical to that of FIG. 5 of another model for an enclosure provided with a vent; and

FIG. 12 is a diagrammatic view identical to that of FIG. 11 of another embodiment for an enclosure provided with a passive radiator.

The sound retrieval installation 10 illustrated in FIG. 1 comprises, as is known in itself, a module 12 for producing an audio signal, such as a digital disc reader connected to a loudspeaker 14 of an enclosure through a voltage amplifier 16. Between the audio source 12 and the amplifier 16, a desired model 20, corresponding to the desired behavior model of the enclosure, and a control device 22 are arranged, successively in series. This desired model is linear or nonlinear.

According to one particular embodiment, a loop 23 for measuring a physical value, such as the temperature of the magnetic circuit of the loudspeaker or the intensity circulating in the coil of the loudspeaker, is provided between the loudspeaker 14 and the control device 22.

The desired model 20 is independent of the loudspeaker used in the installation and its model.

The desired model 20 is, as shown in FIG. 2, a function expressed based on the frequency of the ratio of the amplitude of the desired signal, denoted S_{audio}_{_}_{ref}, to the amplitude S_{audio} of the input signal from the module 12.

Advantageously, for frequencies below a frequency fₘᵢₙ, this ratio is a function converging toward zero when the frequency tends towards zero, to limit the reproduction of excessively low frequencies and thereby avoid movements of the loudspeaker diaphragm outside ranges recommended by the manufacturer.

The same is true for high frequencies, where the ratio tends towards zero beyond a frequency fₘₐₓ when the frequency of the signal tends toward infinity.

According to another embodiment, this desired model is not specified and the desired model is considered to be unitary.

The control device 22, the detailed structure of which is illustrated in FIG. 3, is arranged at the input of the amplifier 16. This device is able to receive, as input, the audio signal S_{audio}_{_}_{ref} to be reproduced as defined at the output of the desired model 20 and to provide, as output, a signal U_{ref}, forming an excitation signal of the loudspeaker that is supplied for amplification to the amplifier 16. This signal U_{ref} is suitable for taking account of the nonlinearity of the loudspeaker 14.

The control device 22 comprises means for calculating different quantities based on derivative or integral values of other quantities defined at the same moments.

For the calculating needs, the values of the quantities not known at the moment n are taken to be equal to the corresponding values at the moment n−1. The values at the moment n−1 are preferably corrected by an order 1 or 2 prediction of their values using higher-order derivatives known at the moment n−1.

According to the invention, the control device 22 implements a control partly using the differential flatness principle, which makes it possible to define a reference control signal of a differentially flat system from sufficiently smooth reference trajectories.

As illustrated in FIG. 3, the control module 22 receives, as input, the audio signal S_{audio}_{_}_{ref} to be reproduced from the desired model 20. A unit 24 for applying a unit conversion gain, depending on the peak voltage of the amplifier 16 and an attenuation variable between 0 and 1 controlled by the user, ensures the passage of the reference audio signal S_{audio}_{_}_{ref} to a signal y₀, image of a physical value to be reproduced. The signal y₀ is, for example, an acceleration of the air opposite the loudspeaker or a speed of the air to be moved by the loudspeaker 14. Hereinafter, it is assumed that the signal y₀ is the acceleration of the air set in motion by the enclosure.

At the output of the amplification unit 24, the control device comprises a unit 25 for structural adaptation of the signal to be reproduced based on the structure of the enclosure in which the loudspeaker is used. This unit is able to provide a desired reference value A_{ref} at each moment for the loudspeaker diaphragm from a corresponding value, here the signal y₀, for the displacement of the air set in motion by the enclosure comprising the loudspeaker.

Thus, in the considered example, the reference value A_{ref}, calculated from the acceleration of the air to be reproduced y₀, is the acceleration to be reproduced for the loudspeaker diaphragm so that the operation of the loudspeaker imposes an acceleration y₀ on the air.

In the case of a closed enclosure in which the loudspeaker is mounted in a closed housing, the desired reference acceleration for the diaphragm A_{ref} is equal to the desired acceleration y₀ for the air.

This reference value A_{ref} is introduced into a unit 26 for calculating reference dynamic values able to provide, at each moment, the value of the derivative relative to the time of the reference value denoted dA_{ref}/dt, as well as the values of the first and second integrals relative to the time of that reference value, respectively denoted V_{ref} and X_{ref}.

The set of reference dynamic values is denoted hereinafter as C_{ref}.

FIG. 4 shows a detail of the calculating unit 26. The input A_{ref} is connected to a derivation unit 30 on the one hand and to a bounded integration unit 32 on the other hand, the output of which is in turn connected to another bounded integration unit 34.

Thus, at the output of the units 30, 32 and 34, the derivative of the acceleration dA_{ref}/dt, the first integral V_{ref} and the second integral X_{ref} of the acceleration are respectively obtained.

The bounded integration units are formed by a first-order low-pass filter and are characterized by a cutoff frequency F_{OBF}.

The use of a bounded integration unit makes it possible for the values used in the control device 22 not to be the derivatives or integrals of one another except in the useful bandwidth, i.e., for frequencies above the cutoff frequency F_{OBF}. This makes it possible to control the low-frequency excursion of the values in question.

During normal operation, the cutoff frequency F_{OBF}is chosen so as not to influence the signal in the low frequencies of the useful bandwidth.

The cutoff frequency F_{OBF} is taken to be lower than one tenth of the frequency fₘᵢₙ of the desired model 20.

The control device 22 comprises, in a memory, a table and/or a set of electromechanical parameter polynomials 36 as well as a table and/or a set of electrical parameter polynomials 38.

These tables 36 and 38 are able to define, based on reference dynamic values G_{ref} received as input, the electromechanical P_{mec} and electrical P_{elec} parameters, respectively. These parameters P_{mec} and P_{elec} are respectively obtained from a mechanical modeling of the loudspeaker as illustrated in FIG. 5 and an electric model of the loudspeaker as illustrated in FIG. 6.

In these figures, the loudspeaker is assumed to be installed in a closed housing with no vent, the diaphragm being at the interface between the outside and the inside of the housing.

The electromechanical parameters P_{mec} include the magnetic flux captured by the coil, denoted BI, produced by the magnetic circuit of the loudspeaker, the stiffness of the loudspeaker, denoted Kₘₜ, the viscous mechanical friction of the loudspeaker, denoted Rₘₜ, and the mobile mass of the entire loudspeaker, denoted Mₘₜ.

The model of the mechanical part of the loudspeaker illustrated in FIG. 5 comprises, in a single closed-loop circuit, a voltage BI(x, i).i generator 40 corresponding to the driving force produced by the current i circulating in the coil of the loudspeaker. The magnetic flux BI(x, i) depends on the position x of the diaphragm as well as the intensity i circulating in the coil.

This model takes into account the viscous mechanical friction Rₘₜ corresponding to a resistance 42 in series with a coil 44 corresponding to the overall mobile mass Mₘₜ, the stiffness corresponding to a capacitor 46 with capacity Cₘₜ (x) equal to 1/Kₘₜ (x). Thus, the stiffness depends on the position x of the diaphragm.

Lastly, the circuit comprises a generator 48 representative of the force resulting from the reluctance of the magnetic circuit denoted Fᵣ (x, i) and equal to

$$\frac{1}{2} {i}^{2} \frac{d {L}_{e} ( x )}{d x}$$

where Lₑ is the inductance of the coil and depends on the position x of the diaphragm.

The variable v represents the speed of the diaphragm.

The electric parameters Pélec include the inductance of the coil Le, the para-inductance L2 of the coil and the iron loss equivalent R2.

The model of the electric part of the loudspeaker of a closed enclosure is illustrated by FIG. 6. It is formed by a closed-loop circuit. It comprises a generator 50 for generating electromotive force connected in series to a resistance 52 representative of the resistance Rₑ of the coil of the loudspeaker. This resistance 52 is connected in series with an inductance Le (x, i) representative of the inductance of the loudspeaker coil. This inductance depends on the intensity i circulating in the coil and the position x of the diaphragm.

To account for magnetic losses and inductance variations by Foucault current effect, a parallel circuit RL is mounted in series at the output of the coil 54. A resistance 56 with value R₂(x, i) depending on the position of the diaphragm x and the intensity i circulating in the coil is representative of the iron loss equivalent. Likewise, a coil 58 with inductance L₂(x, i) also depending on the position x of the diaphragm and the intensity i circulating in the circuit is representative of the para-inductance of the loudspeaker.

Also mounted in series in the model are a voltage generator 60 producing a voltage BI(x, i).v representative of the counter-electromotive force of the coil moving in the magnetic field produced by the magnet and a second generator 62 producing a voltage g(x,i).v with

$$g ( x , i ) = i \frac{d {L}_{e} ( x , i )}{d x}$$

representative of the dynamic variation of the inductance with the position.

In general, it will be noted that, in this model, the flux BI captured by the coil, the stiffness Kₘₜ and the inductance of the coil Lₑ depend on the position x of the diaphragm, the inductance Lₑ and the flux BI also depend on the current i circulating in the coil.

Preferably, the inductance of the coil Lₑ, the inductance L₂ and the term g depend on the intensity i, in addition to depending on the movement x of the diaphragm.

From the models explained in light of FIGS. 5 and 6, the following equations are defined:

$${u}_{e} = {R}_{e} i + {L}_{e} ( x , i ) \frac{d i}{d t} + {R}_{2} ( i - {i}_{2} ) + Bl ( x , i ) v + \underbrace{i \frac{d {L}_{e} ( x , i )}{d x}}_{g ( x , i )} v$$

$${L}_{2} \frac{d {i}_{2}}{d t} = {R}_{2} ( i - {i}_{2} )$$

$$Bl ( x , i ) i = {R}_{mt} v + {M}_{mt} \frac{d v}{d t} + {K}_{mt} ( x ) x + \frac{1}{2} {i}^{2} \frac{d {L}_{e} ( x , i )}{d x}$$

The control module 22 further comprises a unit 70 for calculating the reference current i_{ref} and its derivative di_{ref}/dt. This unit receives, as input, the reference dynamic values G_{ref}, the mechanical parameters P_{méca}. This calculation of the reference current I_{ref} and its derivative dI_{ref}/dt satisfy the following two equations:

$${G}_{1} ( {x}_{ref} , {i}_{ref} ) {i}_{ref} = {R}_{mt} {v}_{ref} + {M}_{mt} {A}_{ref} + {K}_{mt} ( {x}_{ref} ) {x}_{ref}$$

$$\frac{d}{d t} ( {G}_{1} ( {x}_{ref} , {i}_{ref} ) {i}_{ref} ) = {R}_{mt} {A}_{ref} + {M}_{mt} d {A}_{ref} / d t + {K}_{mt} ( {x}_{ref} ) {v}_{ref}$$

$$with {G}_{1} ( {x}_{ref} , {i}_{ref} ) = Bl ( {x}_{ref} , {i}_{ref} ) - \frac{1}{2} {i}_{ref} \frac{d {L}_{e} ( {x}_{ref} , {i}_{ref} )}{d x} .$$

Thus, the current i_{ref} and its derivative di_{ref}/dt are obtained by an algebraic calculation from values of the vectors entered by an exact analytical calculation or a digital resolution if necessary based on the complexity of G₁(x,i).

The derivative of the current di_{ref}/dt is thus preferably obtained through an algebraic calculation, or otherwise by numerical derivation.

To avoid excessive travel of the loudspeaker diaphragm, a movement Xₘₐₓ is imposed on the control module. This is made possible by the use of a separate unit 26 for calculating reference dynamic values and a structural adaptation unit 25.

The limitation of the movement is done by a “virtual wall” device that prevents the loudspeaker diaphragm from exceeding a certain limit linked to Xₘₐₓ. To that end, as the position X_{ref} approaches its limit threshold, the energy necessary for the position to approach the virtual wall becomes increasingly great (nonlinear behavior), to be infinite on the wall with the possibility of imposing an asymmetrical behavior. To that end, the viscous mechanical friction Rₘₜ 42 is increased nonlinearly based on the position x_{ref} of the diaphragm.

According to still another embodiment, to limit the travel, the acceleration A_{ref} is kept dynamically within minimum and maximum limits, which guarantee that the position X_{ref} of the diaphragm does not exceed X_{max.}

In the case where, depending on the embodiment, the travel X_{ref} of the diaphragm is limited to X_{ref}_{_}ₛₐₜ, and the acceleration of the diaphragm A_{ref} to A_{ref}_{_}ₛₐₜ, the values x₀ and v₀ are recalculated at moment n using the following algorithm:

$${γ}_{0 sat} ( n ) = {A}_{ref sat} ( n ) - \frac{{K}_{m 2}}{{R}_{m 2}} {v}_{0 sat} ( n - 1 ) - \frac{{K}_{m 2}}{{M}_{m 2}} {x}_{0 sat} ( n - 1 )$$

v₀ₛₐₜ(n)=bounded integrator of y₀ₛₐₜ(n)(identical to 32)

x₀ₛₐₜ(n)=bounded integrator of v₀ₛₐₜ(n)(identical to 34)

v_{ref sat}(n)=bounded integrator of A_{ref sat}(n)(identical to 32)

The calculation of the reference current I_{ref} and its derivative dI_{ref}/dt then satisfy the following two equations:

$${G}_{1} ( {x}_{ref \_ sat} , {i}_{ref} ) {i}_{ref} = {R}_{mt} {v}_{ref \_ sat} + {M}_{mt} {A}_{ref \_ sat} + {K}_{mt} ( {x}_{ref \_ sat} ) {x}_{ref \_ sat} + {K}_{m 2} {x}_{0 \_ sat}$$

$$\frac{d}{d t} ( {G}_{1} ( {x}_{ref \_ sat} , {i}_{ref} ) {i}_{ref} ) = {R}_{mt} {A}_{ref \_ sat} + {M}_{mt} d {A}_{ref \_ sat} / d t + {K}_{mt} ( {x}_{ref \_ sat} ) {v}_{ref \_ sat} + {K}_{m 2} {x}_{0 \_ sat}$$

$$with {G}_{1} ( {x}_{ref \_ sat} , {i}_{ref} ) = Bl ( {x}_{ref \_ sat} , {i}_{ref} ) - \frac{1}{2} {i}_{ref} \frac{d {L}_{e} ( {x}_{ref \_ sat} , {i}_{ref} )}{d x} .$$

Furthermore, the control device 22 comprises a unit 80 for estimating the resistance Rₑ of the loudspeaker. This unit 80 receives, as input, the reference dynamic values G_{ref}, the intensity of the reference current i_{ref} and its derivative di_{ref}/dt and, depending on the considered embodiment, the temperature measured on the magnetic circuit of the loudspeaker, denoted Tₘ_{_}_{measured} or the intensity measured through the coil, denoted I_{—measured}.

In the absence of a measurement of the circulating current, the estimating unit 80 has the form illustrated in FIG. 7. It comprises, as input, a module 82 for calculating the power and parameters and a thermal model 84.

The thermal model 84 provides the calculation of the resistance Rₑ from calculated parameters, the determined power P_{JB} and the measured temperature Tₘ_{_}_{measured}.

FIG. 8 provides the general diagram used for the thermal model.

In this model, the reference temperature is the temperature of the air inside the enclosure Tₑ.

The considered temperatures are:

T_{b}[° C.]: temperature of the winding;

Tₘ[° C.]: temperature of the magnetic circuit; and

Tₑ[° C.]: inside temperature of the enclosure, assumed to be constant, or ideally measured.

The considered thermal power is:

P_{Jb}[W]: thermal power contributed to the winding by Joule effect;

The thermal model comprises, as illustrated in FIG. 8, the following parameters:

C_{tbb}[J/K]: thermal capacity of the winding;

R_{thbm}[K/W]: equivalent thermal resistance between the winding and the magnetic circuit; and

R_{thba}[K/W]: equivalent thermal resistance between the winding and the inside temperature of the enclosure.

The equivalent thermal resistances take account of the heat dissipation by conduction and convection.

The thermal power P_{Jb} contributed by the current circulating in the winding is given by:

P_{Jb}(t)=Rₑ(T_{b})t²(t)

where Rₑ(T_{b}) is the value of the electrical resistance at the temperature T_{b}:

Rₑ(T_{b})=Rₑ(20° C.)×(1+4.10⁻³(T_{b}-20° C.))

where Rₑ(20° C.) is the value of the electrical resistance at 20° C.

The thermal model given by FIG. 8 is the following:

$${C}_{thb} \frac{d {T}_{b}}{d t} = \frac{1}{{R}_{thbm} ( {X}_{ref} )} ( {T}_{m} - {T}_{b} ) + \frac{1}{{R}_{thba} ( {V}_{ref} )} ( {T}_{e} - {T}_{b} ) + {P}_{Jb}$$

Its resolution makes it possible to obtain the value of the resistance Rₑ at each moment.

Alternatively, as illustrated in FIG. 9, when the current i circulating in the coil is measured, the estimate of the resistance Rₑ is provided by a closed-loop estimator, for example of the proportional integral type. This makes it possible to have a fast convergence time owing to the use of a proportional integral corrector.

Lastly, the control device 22 comprises a unit 90 for calculating the reference output voltage U_{ref}, from reference dynamic values C_{ref}, the reference current i_{ref} and its derivative di_{ref}/dt, electric parameters P_{élec} and the resistance Rₑ calculated by the unit 80.

This unit calculating the reference output voltage implements the following two equations:

$${u}_{2} + \frac{{L}_{2} ( {x}_{ref} , {i}_{ref} )}{{R}_{2} ( {x}_{ref} , {i}_{ref} )} \frac{d {u}_{2}}{d t} = {L}_{2} ( {x}_{ref} , {i}_{ref} ) \frac{d {i}_{ref}}{d t \\}$$

$${u}_{ref} = {R}_{e} {i}_{ref} + {L}_{e} ( {x}_{ref} , {i}_{ref} ) \frac{d {i}_{ref}}{d t} + {u}_{2} + Bl ( {x}_{ref} , {i}_{ref} ) {v}_{ref} + \underbrace{{i}_{ref} \frac{d {L}_{e} ( {x}_{ref} , {i}_{ref} )}{d x}}_{g ( {x}_{ref} , {i}_{ref} )} {v}_{ref}$$

Alternatively, and for an enclosure comprising a housing open via a vent, the mechanical-acoustic model of the loudspeaker illustrated in FIG. 5 is replaced with the model of FIG. 11, and the structural adaptation unit 25 is able to determine the desired acceleration of the membrane A_{ref} from the desired acceleration of the air y₀ to account for the particular structure of the enclosure.

In this embodiment, and as illustrated in FIG. 3, the control module 22 receives, as input, the audio signal S_{audio}_{_}_{ref} to be reproduced from the desired model 20. The unit 24 for applying a unit conversion gain, depending on the peak voltage of the amplifier 10 and an attenuation variable between 0 and 1 controlled by the user, ensures the passage of the reference audio signal S_{audio}_{_}_{ref} to a signal y₀, image of a physical value to be reproduced. The signal y₀ is, for example, an acceleration of the air opposite the loudspeaker or a speed of the air to be moved by the loudspeaker 14. Hereinafter, it is assumed that the signal y₀ is the acceleration of the air set in motion by the enclosure.

The structural adaptation unit 25 of the signal to be reproduced based on the structure of the enclosure in which the loudspeaker is used is able to provide a desired reference value A_{ref} at each moment for the loudspeaker diaphragm from a corresponding value, here the signal, for the displacement of the air set in motion by the device in which the loudspeaker is placed.

Thus, in the considered example, the reference value A_{ref}, calculated from the acceleration of the air to be reproduced y₀, is the acceleration to be reproduced for the loudspeaker diaphragm so that the operation of the loudspeaker imposes an acceleration y₀ on the total air.

FIG. 10 shows a detail of the structural adaptation unit 25. The input y₀ is connected to a bounded integration unit 127, the output of which is in turn connected to another bounded integration unit 128.

Thus, at the output of the units 127 and 128, the first integral v₀ and the second integral xₒ are obtained of the acceleration y₀.

The bounded integration units are formed by a first-order low-pass filter and are characterized by a cutoff frequency F_{OBF}.

The use of a bounded integration unit makes it possible for the values used in the control device 22 not to be the derivatives or integrals of one another except in the useful bandwidth, i.e., for frequencies above the cutoff frequency F_{OBF}. This makes it possible to control the low-frequency excursion of the values in question.

During normal operation, the cutoff frequency F_{OBF} is chosen so as not to influence the signal in the low frequencies of the useful bandwidth.

The cutoff frequency F_{OBF} is taken to be lower than one tenth of the frequency fₘᵢₙ of the desired model 20.

In the case of a vented enclosure in which the loudspeaker is mounted, the unit 25 produces the desired reference acceleration for the diaphragm A_{ref} via the following relationship:

$${A}_{ref} = {γ}_{D} = {γ}_{0} + \frac{{K}_{m 2}}{{R}_{m 2}} {v}_{0} + \frac{{K}_{m 2}}{{R}_{m 2}} {x}_{0}$$

With:

Rₘ₂: acoustic leakage coefficient of the enclosure;

Mₘ₂: inductance equivalent to the mass of air in the vent;

Kₘ₂: stiffness of the air in the enclosure;

x₀: position of the total air displaced by the diaphragm and the vent;

$${v}_{0} = \frac{d {x}_{0}}{d t} \text{:}$$

speed of the diaphragm and the vent;

$${γ}_{0} = \frac{d {v}_{0}}{d t} \text{:}$$

acceleration of the total displaced air.

In this case, the reference acceleration desired for the diaphragm A_{ref} is corrected for structural dynamic values x₀, v₀, of the enclosure, the latter being different from the dynamic values relative to the loudspeaker diaphragm.

This reference value A_{ref} is introduced into a unit 26 for calculating reference dynamic values able to provide, at each moment, the value of the derivative relative to the time of the reference value denoted dA_{ref}/dt, as well as the values of the first and second integrals relative to the time of that reference value, respectively denoted V_{ref} and X_{ref}.

The set of reference dynamic values is denoted hereinafter as G_{ref}.

The structural adaptation unit 25 also comprises a calculating unit identical to 26 in order to determine the reference dynamic values v₀ and x₀.

The calculating unit 26 is illustrated in FIG. 4 and is that of the preceding embodiment.

As before, the tables 36 and 38 are able to define, based on reference dynamic values G_{ref} received as input, the electromechanical P_{mec} and electrical P_{elec} parameters, respectively. These parameters P_{mec} and P_{elec} are respectively obtained from a mechanical model of the loudspeaker as illustrated in FIG. 11, where the loudspeaker is assumed to be installed in a vented enclosure, and an electrical model of the loudspeaker as illustrated in FIG. 6.

The electromechanical parameters P_{mec} include the magnetic flux captured by the coil, denoted BI, produced by the magnetic circuit of the loudspeaker, the stiffness of the loudspeaker, denoted Kₘₜ(x_{D}), the viscous mechanical friction of the loudspeaker, denoted Rₘₜ, the mobile mass of the entire loudspeaker, denoted Mₘₜ, the stiffness of the air in the enclosure, denoted Kₘ₂, the acoustic leakages of the enclosure, denoted Rₘ₂, and the air mass in the vent denoted Mₘ₂.

The last three quantities that are integrated in P_{mec} do not appear in FIG. 3.

The model of the mechanical-acoustic part of the loudspeaker placed in a vented enclosure illustrated in FIG. 11 comprises, in a single closed-loop circuit, a voltage BI(x_{D}, i).i generator 140 corresponding to the driving force produced by the current i circulating in the coil of the loudspeaker. The magnetic flux BI(x_{D}, i) depends on the position x_{D} of the diaphragm as well as the intensity i circulating in the coil.

This model takes into account the viscous mechanical friction Rₘₜ of the diaphragm corresponding to a resistance 142 in series with a coil 144 corresponding to the overall mobile mass Mₘₜ of the diaphragm, the stiffness of the diaphragm corresponding to a capacitor 146 with capacity Cₘₜ (x_{D}) equal to 1/Kₘₜ (x_{D}). Thus, the stiffness depends on the position x_{D} of the diaphragm.

To account for the vent, the following parameters Rₘ₂, Cₘ₂ and Mₘ₂ were used:

Rₘ₂: acoustic leakage coefficient of the enclosure;

Mₘ₂: inductance equivalent to the mass of air in the vent;

$${C}_{m 2} = \frac{1}{{K}_{m 2}} \text{:}$$

compliance of the air in the enclosure.

In the model of FIG. 11, they respectively correspond to a resistance 147, a coil 148 and a capacitor 149 mounted in parallel.

In this model, the force resulting from the reluctance of the magnetic circuit is ignored.

The variables used are:

$${v}_{D} = \frac{d {x}_{D}}{d t} \text{:}$$

speed of the loudspeaker diaphragm

$${γ}_{D} = \frac{d {v}_{D}}{d t} \text{:}$$

acceleration of the loudspeaker diaphragm

v_{L}: speed of the air from air leakages

vₚ: speed of the air leaving the vent (port)

$${v}_{0} = \frac{d {x}_{0}}{d t} = {v}_{D} + {v}_{L} + {v}_{p} \text{:}$$

speed of the total air displaced by the diaphragm and the vent;

$${γ}_{D} = \frac{d {v}_{0}}{d t} \text{:}$$

acceleration of the total displaced air.

The total acoustic pressure at 1 meter is given by:

$$p = \frac{ρ . {S}_{D}}{{n}_{str} π .} {γ}_{0}$$

where S_{D}: cross section of the loudspeaker, nₛₜᵣ=2: solid emission angle.

The mechanical-acoustic equation corresponding to FIG. 11 is the following:

$$Bl ( {x}_{D} , i ) i = {M}_{mt} \frac{d {v}_{D}}{d t} + {R}_{mt} {v}_{D} + {K}_{mt} ( {x}_{D} ) {x}_{D} + {K}_{m 2} {x}_{0}$$

The following relationship links the different values:

$${γ}_{0} = {γ}_{D} - \frac{{K}_{m2}}{{R}_{m2}} {v}_{0} - \frac{{K}_{m2}}{{M}_{m2}} {x}_{0}$$

The modeling of the electric part of the loudspeaker is illustrated by FIG. 6 and is identical to that of the first embodiment.

From the models explained in light of FIGS. 11 and 6, the following equations are defined:

$${u}_{e} = {R}_{e} i + {L}_{e} ( {x}_{D} , i ) \frac{d i}{d t} + {R}_{2} ( i - {i}_{2} ) + Bl ( {x}_{D} , i ) {v}_{D} + \underbrace{i \frac{d {L}_{e} ( {x}_{D} , i )}{d {x}_{D}}}_{g ( {x}_{D} , i )} {v}_{D}$$

$${L}_{2} \frac{d {i}_{2}}{d t} = {R}_{2} ( i - {i}_{2} )$$

$$Bl ( {x}_{D} , i ) i = {R}_{mt} {v}_{D} + {M}_{mt} \frac{d {v}_{D}}{d t} + {K}_{mt} ( {x}_{D} ) {x}_{D} + {K}_{m 2} {x}_{0} \\$$

The control module 22 further comprises a unit 70 for calculating the reference current i_{ref} and its derivative di_{ref}/dt. This unit receives, as input, the reference dynamic values C_{ref}, the mechanical parameters P_{méca}, and the values x₀ and v₀. This calculation of the reference current i_{ref} and its derivative dI_{ref}/dt satisfy the following two equations:

$${G}_{1} ( {x}_{ref} , {i}_{ref} ) {i}_{ref} = {R}_{mt} {v}_{ref} + {M}_{mt} {A}_{ref} + {K}_{mt} ( {x}_{ref} ) {x}_{ref} + {K}_{m 2} {x}_{0 \\}$$

$$\frac{d}{d t} ( {G}_{1} ( {x}_{ref} , {i}_{ref} ) {i}_{ref} ) = {R}_{mt} {A}_{ref} + {M}_{mt} d {A}_{ref} / d t + {K}_{mt} ( {x}_{ref} ) {v}_{ref} + {K}_{m 2} {v}_{0}$$

$$with {G}_{1} ( {x}_{ref} , {i}_{ref} ) = Bl ( {x}_{ref} , {i}_{ref} ) - \frac{1}{2} {i}_{ref} \frac{d {L}_{e} ( {x}_{ref} , {i}_{ref} )}{d x} .$$

Thus, the current i_{ref} and its derivative di_{ref}/dt are obtained by an algebraic calculation from values of the vectors entered by an exact analytical calculation or a digital resolution if necessary based on the complexity of G₁(x,i).

The derivative of the current di_{ref}/dt is thus preferably obtained through an algebraic calculation, or otherwise by numerical derivation.

To avoid excessive travel of the loudspeaker diaphragm, a movement Xₘₐₓ is imposed on the control module as in the preceding embodiment.

Furthermore, the control device 22 comprises a unit 80 for estimating the resistance Rₑ of the loudspeaker, as described in light of the preceding embodiment.

If the amplifier 16 is a current amplifier and not a voltage amplifier as previously described, the units 38, 80 and 90 of the control device are eliminated and the reference output intensity i_{ref} controlling the amplifier is taken at the output of the unit 70.

In the case of an enclosure comprising a passive radiator formed by a diaphragm, the mechanical model of FIG. 6 is replaced by that of FIG. 12, in which the elements identical to those of FIG. 6 bear the same reference numbers. This module comprises, in series with the coil Mₘ₂ 48, corresponding to the mass of the diaphragm of the passive radiator, a resistance 202 and a capacitor 204 with value

$${C}_{m 3} = \frac{1}{{K}_{m 3}}$$

respectively corresponding to the mechanical losses Rₘ₂ of the passive radiator and the mechanical stiffness Kₘ₃ of the diaphragm of the passive radiator. The reference acceleration of the diaphragm A_{ref} is given by:

$${A}_{ref} = {γ}_{0} + \frac{{K}_{m2}}{{R}_{m2}} {v}_{0} + \frac{{K}_{m2}}{{M}_{m2}} {x}_{0 R}$$

With x_{0R} given by filtering by a high-pass filter of x₀:

$${x}_{0 R} = \frac{{s}^{2}}{{s}^{2} + \frac{{R}_{m 3}}{{M}_{m 2}} s + \frac{{K}_{m 3}}{{M}_{m 2}}} {x}_{0}$$

Thus, the structural adaptation structure 25 comprises, in series, two bounded integrators in order to obtain v₀ et x₀ from y₀, then to calculate x_{0R} from x₀ by high-pass filtering with the additional parameters Rₘ₃ and Kₘ₃ which are, respectively, the mechanical loss resistance and the mechanical stiffness constant of the diaphragm of the passive radiator.

1. Device for controlling a loudspeaker in an enclosure, comprising:
an input for an audio signal to be reproduced;
an output for supplying an excitation signal for the loudspeaker;
wherein it comprises a control unit comprising:
means for calculating a desired dynamic value of the loudspeaker diaphragm based on the audio signal to be reproduced and the structure of the enclosure;
means for calculating a plurality of desired dynamic values of the loudspeaker diaphragm, at each moment, based on only the desired dynamic value;
a mechanical model of the loudspeaker; and
means for calculating the excitation signal of the loudspeaker at each moment, without feedback loop, from the mechanical model of the loudspeaker and the desired dynamic values.

2. Device for controlling a loudspeaker according to claim 1, wherein said control unit further comprises an electric model of the loudspeaker, and the means for calculating the excitation signal at each moment are able to calculate the excitation signal further based on the electric model of the loudspeaker.

3. Device for controlling a loudspeaker according to claim 2, wherein the electric model of the loudspeaker takes into account:
a resistance representative of the magnetic losses of the loudspeaker;
an inductance representative of a para-inductance resulting from the effect of the Foucault currents in the loudspeaker.

4. Device for controlling a loudspeaker according to claim 2, wherein the electric model of the loudspeaker takes account of the variation of the inductance of the loudspeaker coil based on the intensity circulating in the loudspeaker.

5. Device for controlling a loudspeaker according to claim 2, wherein the electric model of the loudspeaker takes account of the variation of the inductance of the loudspeaker coil based on the position of the coil diaphragm.

6. Device for controlling a loudspeaker according to claim 2, wherein the electric model of the loudspeaker takes account of the variation of the magnetic flux captured by the loudspeaker coil based on the intensity circulating in the loudspeaker.

7. Device for controlling a loudspeaker according to wherein the electric model of the loudspeaker takes account of the variation of the magnetic flux captured by the loudspeaker coil based on the position of the coil diaphragm.

8. Device for controlling a loudspeaker according to claim 2, wherein the electric model of the loudspeaker takes account of the variation of the derivative of the inductance relative to time of the loudspeaker coil based on the intensity circulating in the loudspeaker.

9. Device for controlling a loudspeaker according to c claim 2, wherein the electric model of the loudspeaker takes account of the variation of the derivative of the inductance relative to time of the loudspeaker coil based on the position of the coil diaphragm.

10. Device for controlling a loudspeaker according to claim 2, wherein the electric model of the loudspeaker takes account of the variation of the resistance of the loudspeaker coil based on a measured temperature of the magnetic circuit of the loudspeaker.

11. Device for controlling a loudspeaker according to claim 2, wherein the electric model of the loudspeaker takes account of the variation of the resistance of the loudspeaker coil based on an intensity measured in the loudspeaker coil.

12. Device for controlling a loudspeaker according to claim 1, wherein the means for calculating the desired dynamic values based on the audio signal to be reproduced comprise at least one bounded integrator characterized by a cutoff frequency limiting the integration in the useful bandwidth below the cutoff frequency.

13. Device for controlling a loudspeaker according to claim 1, wherein the plurality of desired dynamic values are the set of values at a given moment of four functions which are different-order derivatives of a same function.

14. Device for controlling a loudspeaker according to claim 1, wherein the means for calculating desired dynamic values are able to provide calculations of desired dynamic values by integration and/or derivation of the audio signal to be reproduced.

15. Device for controlling a loudspeaker according to claim 1, wherein the means for calculating the excitation signal, without feedback loop, from desired dynamic values are able to provide algebraic calculations of the intensity of the desired current in the coil and of the derivative relative to time of the intensity of the desired current in the coil.

16. Device for controlling a loudspeaker according to claim 1, wherein the mechanical model of the loudspeaker takes account of the mechanical friction of the loudspeaker, and the device comprises means so that the resistance depends on at least one of the desired dynamic values according to a nonlinear increasing function tending toward infinity when at least one of the desired dynamic values tends toward a predetermined value.

17. Device for controlling a loudspeaker according to claim 1, wherein the plurality of desired dynamic values comprise the acceleration of the loudspeaker diaphragm and the position of the loudspeaker diaphragm, and the device comprises means for limiting the acceleration in a predetermined interval, to limit the excursions of the position of the diaphragm beyond a predetermined value.

18. Device for controlling a loudspeaker according to claim 1, wherein the means for calculating the dynamic value of the loudspeaker diaphragm are able to apply a correction that is different from the identity, and take account of structural dynamic values of the enclosure that are different from the dynamic values relative to the loudspeaker diaphragm.

19. (canceled)

20. (canceled)

21. (canceled)

22. Device according to claim 1, wherein the enclosure is a vented enclosure and the structural dynamic values of the enclosure depend on at least one of the following parameters:
acoustic leakage coefficient of the enclosure,
inductance equivalent to the mass of air in the vent,
compliance of the air in the enclosure.

23. Device according to claim 1, wherein the enclosure is a passive radiator enclosure and the structural dynamic values of the enclosure depend on at least one of the following parameters:
acoustic leakage coefficient of the enclosure
inductance equivalent to the mass of the diaphragm of the passive radiator
compliance of the air in the enclosure
mechanical losses of the passive radiator
mechanical compliance of the diaphragm.
